(19) United States
(12) Patent Application Publication
(10) Pub. No.: US 2012/0303507 A1
(43) Pub. Date: Nov. 29, 2012

(54) Interface for Electronic Trading Platform

(75) Inventors: Jason Arnold, Hoffman Estates, IL (US); Leslie Rosenthal, Chicago, IL (US); Adam Marzi, Chicago, IL (US); Timothy P. Gebhardt, Palatine, IL (US); John Robert Collins, Burr Ridge, IL (US)

(73) Assignee: ROSENTHAL COLLINS GROUP, LLC, Chicago, IL (US)

(21) Appl. No.: 13/116,883

(22) Filed: May 26, 2011

(51) Int. Cl. G06Q 40/00

(52) U.S. Cl. 705/37

(57) ABSTRACT

An electronic trading platform provides a system and methods including an interface for presenting market data and receiving user input for entering orders to buy and sell financial instruments on an exchange. The interface includes an order entry window adapted to display price information relating to a financial instrument traded on the exchange. The price information is presented as a portion of price spectrum including all possible prices for the financial instrument. The portion of the price spectrum is presented within the order entry window in a first dynamic mode when operational focus is on an interface window other than the order entry window, and the portion of the price spectrum is presented within the order entry window in a static or partially static order entry mode when operational focus is on the order entry window. Orders to buy and sell the financial instrument are created by, among other things, selecting a price and a quantity to be included in the order to buy or sell the financial instrument.

### BACKGROUND

Trading financial instruments, such as stocks, bonds, futures contracts, commodities, etc., on an exchange has increasingly become a remote impersonal affair. Whereas in the past traders gathered in designated trading pits located at an exchange to trade specific financial instruments face to face, today a great deal of trading is accomplished remotely over data communications networks. In this trading environment an exchange sends market data to traders, and traders submit bids and offers to buy or sell various financial instruments to the exchange over a data communication network. Trades are then executed by the exchange by matching coinciding bids and offers.

In the past, when traders met in the pits at the exchange, traders could keep track of the market and take positions based on what was happening around them. With electronic trading, information about the market must be received from the exchange and displayed for the traders in a logical and coherent manner that allows the traders to quickly assess market conditions. The traders must also be able to quickly create orders that can be submitted to the exchange in order to take positions in the market and to take advantage of opportunities the traders see based on current market conditions.

Electronic trading platforms have been developed to both display market data for traders and to allow traders to create and to submit orders to an exchange. Creating an effective interface for such electronic trading platforms has proven to be a challenge. Many markets have great volatility. Prices change frequently by unpredictable amounts at unpredictable times and in unpredictable directions. A trader may want to take a position quickly based on the current market conditions. If it takes too long to generate and submit an order, however, the market may have already moved by the time the order is submitted. In this case, the order generated by the trader may no longer be appropriate for the new market conditions. Therefore, an effective trading platform must be able to display current market conditions in an easily digestible manner and must allow traders to react to the market quickly. Some trading platform interfaces have addressed this issue by combining the display of market data with the selection of the price for orders to be submitted to exchange. In such trading interfaces the current market price of a financial instrument is displayed in an interface order entry window. The current price is displayed along with a plurality of additional prices near the current price. Market data such as current bids and asks may be displayed along with current price data. According to such interfaces, a trader may select a price for an order to buy or sell a financial instrument by selecting (via mouse-click for example) one of the prices displayed in the order entry window.

Two problems arise with this arrangement. First, prices typically change very rapidly. If the prices displayed in the order entry window are updated continuously it becomes very difficult for a trader to isolate the particular price at which he or she wants to place a buy or sell order in the market. The second problem is that if prices displayed in the order entry window are displayed statically, i.e., they are not continuously updated in real-time, the displayed price may not accurately reflect the current state of the market, and the trader may make poor judgments based on obsolete information.

An improved interface must resolve these competing interests. Preferably a trading platform interface will display market prices in real-time so that a trader may make decisions based on fresh data. Also, it is desirable that the trading platform interface hold the displayed prices steady at or near the time the trader is selecting a price for an order to insure that the trader selects the intended price. Such an interface must also provide an efficient mechanism for identifying a quantity associated with orders to buy and sell financial instruments as well as identifying the type of order the trader would like to enter.

### SUMMARY

The present disclosure describes systems and methods for displaying market data and for entering orders to buy and sell financial instruments traded on an exchange. A trading platform is provided that is adapted to continuously receive market data from an exchange, and to display the market data on a graphical user interface (GUI). The trading platform is further adapted to receive user input via the GUI and to create orders to buy and sell financial instruments listed on the exchange based on the user input, and to communicate orders to the exchange for execution at the exchange.

A method of displaying market data is provided according to a first embodiment. The method includes receiving market data from an exchange on which a financial instrument is traded. The market data includes substantially real-time price data for the financial instrument, including a last traded price, a highest bid price, and a lowest ask price for the financial instrument and may also include all of the bid and ask quantities and their respective prices that are currently in the market (market depth). In the present context, substantially real-time market data relates to market data that is displayed as quickly as it can be received from the exchange and displayed by the display device. There are no purposeful delays in presenting the data. A computer workstation executes a financial instrument trading platform in application. The trading platform application provides an interactive GUI display window that is displayed on a display device associated with a computer workstation executing the financial instrument trading application. The method then calls for displaying a portion of a price spectrum in the GUI window. The price spectrum includes a plurality of incremental price values linearly arranged in numeric order. Next, the method calls for determining whether the GUI window has operational focus of the trading application. The portion of the price spectrum is displayed in the GUI window in a first mode when the GUI window does not have operational focus of the trading application, and in a second mode when the GUI window has operational focus of the trading application. In the first mode, the portion of the price spectrum is displayed dynamically centered on one of the last traded price, the highest bid price, or the lowest ask price. In the second mode the portion of the price spectrum is displayed for a predefined period of time centered on a first value of one of the last traded price, the highest bid price, or the lowest ask price established at a time when the GUI window received operational focus of the trading application. Upon expiration of the period of time, the portion of the price spectrum displayed in the GUI is displayed centered on a second value of the last traded price, highest bid price or lowest ask price established at the expiration of the period of time.

A system for trading financial instruments on an exchange is provided in another embodiment. The trading system includes a processor, a display device, an input device, a communication module and a computer readable memory. The input device is adapted to control a position of a cursor on the display device and to register user selection of one or more graphical objects displayed on the display device. The communication module is provided for receiving market data associated with the financial instrument from the exchange and for sending orders to the exchange to buy or sell financial instruments. The computer readable memory stores instructions which, when executed by the processor, cause the processor to display a GUI on the display device. The GUI includes an order entry window. The order entry window defines a price display region adapted to display a portion of a price spectrum associated with a financial instrument. The price spectrum is displayed in a first mode when the cursor is positioned outside the order entry window, and in a second mode when the cursor is positioned within the order entry window. The first mode is a dynamic price display mode in which the display region is continuously updated to reflect the market data received from the exchange. The second mode is a static price display mode in which a portion of the price spectrum centered on a price determined at a time when the cursor is moved into the order entry window is displayed on the display for a period of time. A different portion of the price spectrum centered on a price determined at the expiration of the period of time is displayed in the display region after the expiration of the period of time.

Yet another embodiment provides an interface for displaying market data associated with a financial instrument traded on an exchange. The interface is also provided for receiving user input for placing orders to buy and sell the financial instrument on the exchange. The interface includes a display device for presenting a plurality of interactive windows in a display area and an input device for interacting with the interactive windows. One of the interactive windows is an order entry window. The order entry window includes a price display region adapted to display a plurality of price values in one of a dynamic price monitoring mode, or a static order entry mode. In the dynamic price monitoring mode the plurality of price values displayed in the price display region are updated on a substantially continuous basis according to market data received from the exchange. The prices are displayed centered around a last traded price value or best bid or lowest ask price. In the static order entry mode, the plurality of price values are statically displayed for a period of time centered around a last traded price value displayed at the time the interface entered the order entry mode. At the end of the period of time, the plurality of price values are displayed centered around a new last traded price value corresponding to the last traded price value received from the exchange at a time corresponding to the time when the period of time expired. In the static mode, the user may manually change the price values that are displayed in the price display region using a mouse scroll wheel or other input device. The user may change the price values displayed in the price display region by mouse clicking the highest or lowest displayed price value to view higher or lower price values respectively.

Still another embodiment provides a method of entering an order to buy or sell a financial instrument on an exchange. This method calls for providing a graphical user interface (GUI) for receiving market data related to the financial instrument. The method further calls for presenting a plurality of price selections for buying and selling the financial instrument via the GUI and setting an order quantity to zero. Next the method calls for providing a graphical element via the GUI for setting the order quantity to a value corresponding to a desired order quantity and receiving an input via user interaction with the graphical element for setting the order quantity to a non-zero value. Upon receiving the user input, the method calls for actually setting the order quantity to the non-zero value. Then the method call for receiving a buy or sell input via the GUI wherein the buy or sell input corresponds to a price selected from among the plurality of price options. The buy or sell input also indicates an order type. Next, the method calls for sending an order to the exchange to buy or sell the financial instrument. The order specifies a price corresponding to the price selected from among said plurality of price options, an order type corresponding to the order type indicated by the received buy or sell input, and a quantity equal to the non-zero quantity value. Finally, the method calls for resetting the order quantity to zero.

### BRIEF DESCRIPTION OF THE DRAWINGS

FIG. 1 is a block diagram of a network implementing electronic trading on an exchange.

FIG. 2 is a GUI display window for a financial instrument trading platform including a plurality of interactive windows.

FIG. 3 is a detailed view of an Order Entry window.

FIG. 4 is a diagram showing a portion of a price spectrum displayed centered around a first price value.

FIG. 5 is a diagram showing a portion of the price spectrum of FIG. 4 displayed centered around a second price value.

FIG. 6 is a diagram showing a portion of the price spectrum of FIGS. 4 and 5 displayed centered around a third price value.

FIG. 7 is a diagram showing the Bids, Price and Asks columns of an order entry window in order entry mode.

FIG. 8 is a diagram showing the Bids, Price and Asks columns of the order entry window shown in FIG. 7 in order entry mode after the market data for a financial instrument associated with the order entry window has changed.

FIG. 9 is a diagram showing the Bids, Price and Asks columns of the order entry window shown in FIGS. 7 and 8 in order entry mode after the market data for the financial instrument associated with the order entry window has changed still further.

FIG. 10 is a diagram showing the Bids, Price and Asks columns of the order entry window shown in order entry mode in FIGS. 7, 8 and 9 after the price column has been manually repositioned.

### DETAILED DESCRIPTION

The present invention relates to an electronic trading platform for trading financial instruments listed on an exchange. The financial instruments traded using the trading platform may include substantially any financial instrument or product that may be traded on an exchange, including, but not limited to, stocks, bonds, futures contracts, commodities, derivatives, pollution credits, or any other instrument, contract or product for which a market exists and which has been listed on an exchange. The trading platform is adapted to continuously receive market data from an exchange, display the market data on a graphical user interface ((GUI), receive user input via the GUI to create orders to buy and sell financial instruments listed on the exchange, and to communicate the orders to the exchange for execution by the exchange.

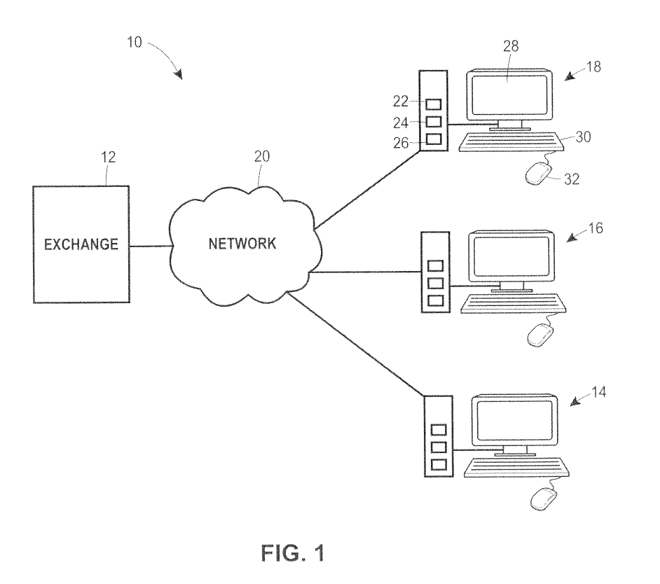

FIG. 1 is block diagram 10 of a network for implementing electronic trading on an exchange 12. One or more client workstations 14, 16, 18 communicate with the exchange 12 via a data communication network 20. The client workstations 14, 16, 18 may be general purpose computer workstations having a processor 22 and a memory 24 storing software instructions which, when executed by the processor, implement the trading platform. The client workstations 14, 16, 18 further include a network communication module 26 for receiving market data from the exchange and for sending orders to the exchange 12 to buy and sell the financial instruments listed on the exchange 12 via the network 20. The network 20 may be a proprietary network owned by the exchange 12 to which traders may purchase access via a subscription arrangement or some other fee agreement. The workstations 14, 16, 18 further include one or more display devices 28 for presenting market data to a user, as well as one or more input devices such as a computer keyboard 30 and a mouse 32 (or some other input device such as a trackball touch paid or the like, for controlling the position of a pointer or cursor on a display device and selecting graphical elements displayed on the display device). The mouse 32 may include one or more user inputs for registering user selection of various graphical elements of the GUI displayed on the display device 28 based on the position of the cursor within a display window of the GUI. For example, the mouse 32 may include both left-click and right-click buttons. Left-clicking on a graphical element of the GUI may signal the user's intent to perform a first action with respect to the graphical element, while right-clicking on the same graphical element may signal the user's intent to perform a second action with respect to the graphical element. The mouse 32 or other pointing device may also include a scroll wheel or some similar mechanism for quickly scrolling though a GUI window, or some portion of a GUI window, in order to display data or a region of the GUI window that is outside a displayed portion of the GUI window.

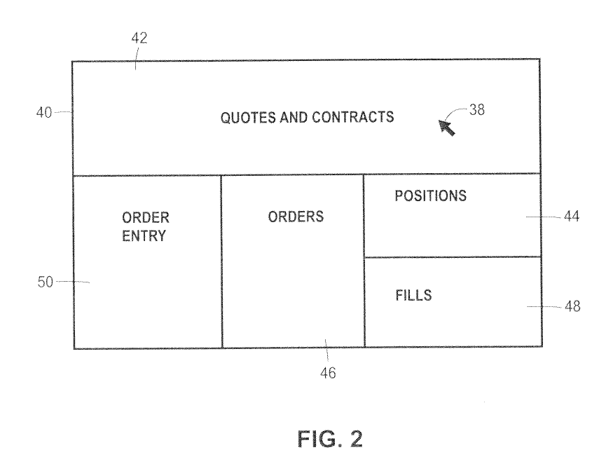

FIG. 2 shows a display screen 40 on which a GUI window 40 is displayed. The GUI window 40 provides a number of configurable interactive windows including a Quotes and Contracts window 42, a Positions window 44, an Orders window 46, a Fills window 48 and an Order Entry window 50. The Quotes and Contracts window 42 displays live streaming data for any financial instrument available to the user. The Positions window 44 allows the user to monitor all of his or her open positions and displays profits and losses for each open position. The Positions Window 44 further allows the user to open and close positions and set trailing stops via an electronic trading ticket that may be opened by selecting one of the user's displayed positions. The Orders Window 46 displays all of the user's orders placed during the current trading session in a configurable grid. The Orders Window 46 displays all orders for all of the user's accounts, and displays details about each order, including the order ID, side (buy, sell), quantity, price, filled, not filled, etc. The Orders Window 46 further allows the user to view an order's history, and allows the user to amend working orders via an electronic trade ticket. The Fills window 48 displays all of the user's filled orders. The Fills window includes user selectable soft buttons for closing a position and reversing a position. Finally, the Order Entry window 50 allows a user to monitor market data for a particular financial instrument in substantially real-time and quickly create and enter orders to take advantage of changing market conditions. The Order Entry window 50 relates to a single financial instrument, but a user may open multiple Order Entry windows at the same time to monitor the market for multiple financial instruments simultaneously and enter orders for different financial instruments as market conditions demand. The particular windows presented by the GUI are user selectable. The arrangement and size of the various windows are also configurable and may be set according to the user's preferences.

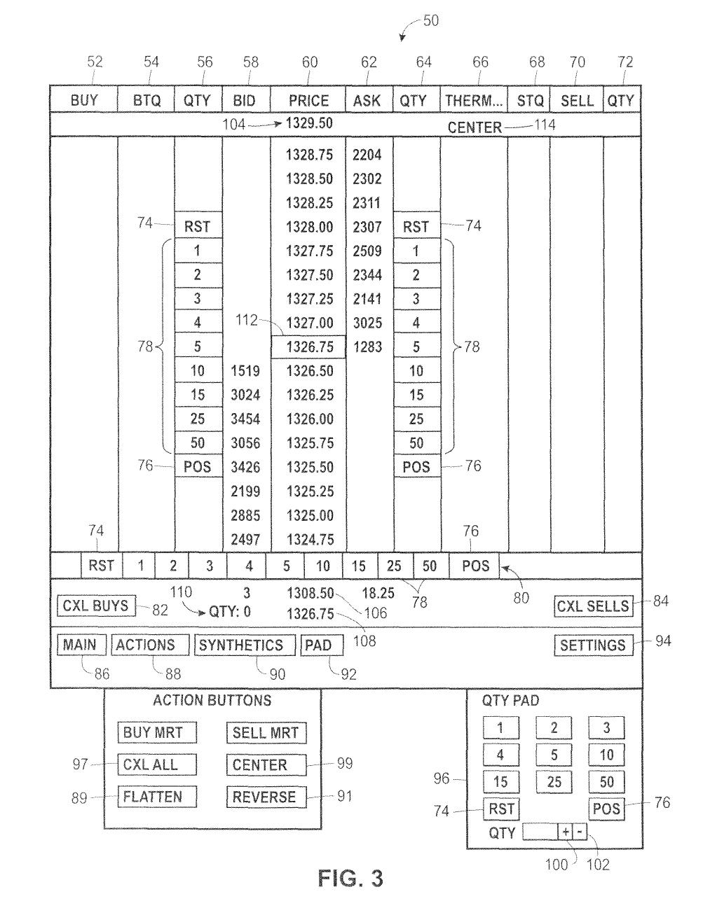

FIG. 3 shows a detailed view of an order entry window 50. The order entry window 50 is generally organized into a plurality of columns for dynamically displaying market data, including the user's positions and for receiving user input for placing orders to buy and sell the particular financial instrument associated with the order entry window 50. Additional information and various user selectable soft buttons are displayed above and below the various columns that make up the larger part of the order entry window 50.

Central to the order entry window 50 is the Price column 60. The price column displays a plurality of vertically arranged incremental prices arranged in ascending order. Each value defines a unique price associated for the financial instrument associated with the order entry window 50. The particular values that are displayed in the Price column 60 represent only a portion of a continuous price spectrum that includes all possible prices for the financial instrument. The value of each adjacent entry in the price spectrum is separated by a single increment or “tick.” A tick represents the smallest incremental change in the price of the financial instrument recognized by the exchange. The financial instrument associated with the Order Entry window 50 may only be bought and sold in price increments of one or more ticks. In the Order Entry window 50 shown in FIG. 3, one tick equals $0.25. Thus, the values shown in the Price column 60 increase in $0.25 increments as one moves up the Price column 60.

The other columns in the Order Entry window 50 include a Buy column 52, a BTQ column 54, a Bid column 58, an Ask column 62, a Market Thermometer column 66, an STQ column 68, a Sell column 70 and a QTY column 72. These columns are all organized around the values displayed in the Price column 60. Data displayed in these columns and user actions that take place in these columns (such as entering an order to buy or sell the financial instrument) correspond to the value in the Price column 60 that appears in the same horizontal row as the data displayed in the other columns or in which the user takes an action.

The Bid column 58 dynamically displays market data received from the exchange indicating the number of lots (i.e. the number of financial instruments) for which bids have been placed to purchase the financial instrument at a particular price. Thus, the value 1519 shown in the Bids column 58 adjacent the value 1326.50 in the Price column 60 indicates that bids to purchase a total quantity of 1519 lots of the financial instrument at $1326.50 have been placed on the market. The value 3024 in the Bid column 58 adjacent the value 1326.25 in the Price column 60 indicates that bids to purchase 3024 lots at $1326.25 have been placed on the market, and so forth.

The Ask column 62 is arranged in a similar manner. The Ask column 62 dynamically displays market data received from the exchange indicating the number of lots that have been offered for sale at a particular asking price. Thus, the value 1283 shown in the Ask column 62 adjacent the value 1326.75 in the Price column 60 indicates that orders to sell a total of 1283 lots at an asking price of $1326.75 have been placed on the market. Likewise, the value 3025 in the Ask column 62 adjacent the value 1327.00 in the Price column 60 indicates that orders to sell 3026 lots at $1327.00 have been placed on the market, and so forth.

The value 1326.50 in the Price column 60 adjacent the uppermost value in the Bids column 58 represents the current highest bid price. The value 1326.75 in the Price column 60 adjacent the lowermost value in the Ask column 62 represents the current lowest ask price. The current highest bid price and the current lowest ask price define what is known as “the inside market,” which indicates the price range at which the next trade will clear. Additional quantities for bids at prices lower than the current best bid price and ask prices that are higher than the current lowest ask price are displayed in order to show market depth. The market depth may provide insights into the possible future direction of the market and may influence a user's decision to alter his or her positions. As the price of the financial instrument moves higher or lower, the inside market necessarily moves along with it.

The BTQ column 54 and the STQ column 68 display the total sum quantity of all outstanding buy orders and the total sum quantity of all outstanding sell orders placed on the market for a particular account, respectively. The Buy column 50 displays buy orders placed by the user, and the Sell column 70 displays sell orders placed by the user. The Buy and Sell columns display both the type and quantity of the entered orders. A limit order is denoted by the abbreviation LT followed by a number indicating the quantity, and a stop order is denoted by the abbreviation ST followed by the quantity.

The QTY column 72 dynamically displays the total quantity trading at the current price. The number in parenthesis next to the total quantity indicates the quantity included in the last trade at that particular price.

The Therm . . . column 66 provides a “price thermometer.” The price thermometer provides a straightforward indication of the market direction from the time at which the order entry window 50 was opened or from the last time the price thermometer was manually centered. The price thermometer may be manually centered by selecting the Center soft button 114 located at the top of the Therm . . . column 66. The price thermometer highlights a region of the Therm . . . column 66 between a price corresponding to the last traded price at the time the order entry window 50 was opened (or the last traded price at the time the price thermometer was manually centered) and the current last traded price. If the market has moved up during that period, the highlighted region maybe shaded green. If the market has moved down the region may be shaded red. (Of course, other colors or indicators may be provided as well.) The price thermometer also displays a number indicating the number of ticks the market has moved in either direction.

Two Quantity (Qty) columns 56, 64 may be included adjacent the Bid and Ask columns 46, 50. Unlike the other columns in the Order Entry window 50, the values displayed in the Qty columns 56, 64 do not have any relation to the prices displayed in the price column 64. Rather, the values displayed in the QTY columns 56, 64 (including RST and POS) are actually user selectable soft buttons for setting the quantity for orders to buy and sell the financial instrument placed by the user. The soft buttons included in the QTY columns 56, 64 are repeated in a QTY row 80 that runs along the bottom of the plurality of columns in the order entry window 50 and in a separate QTY Pad pop-up window 96. The QTY Pad pop-up window 96 is accessed via a Pad soft button 92 located at the bottom of the order entry window 50. The QTY columns 56, 64, and the QTY row 80 may be selected to be displayed or not displayed according to user preferences set via user selections in a settings window (not shown). Further, the locations where the QTY columns 56, 64 are displayed may also be user selectable, as may be the particular values included in the QTY columns 56, 64, the QTY row 80 and the QTY Pad 96. As will be discussed in more detail below, a user must select a quantity using the QTY columns 56, 64, the QTY row 80 or the QTY Pad 96 each time the user enters a new order. The QTY columns 56, 64, the QTY row and the QTY pad each include an RST button 74 and a POS button 76. The RST button 74 resets the current quantity value and the current price to 0.The POS button 76 sets the quantity equal to the total quantity for orders for the particular financial instrument associated with the order entry window 50 placed in an account the user is currently trading in. The values of the numeric buttons included in the QTY columns 56, 64, the QTY row 80 and the Qty pad are configurable and may be selected according to the user's preferences.

Additional information displayed in the order entry window includes the daily high 104, which is displayed in red just above the Price column 60, and the daily low 106, which is displayed in blue just below the Price column 60. The last traded price 108 is also displayed in gray just below the daily low 106.

A number of interface soft buttons are arrayed along the bottom of the order entry window 50. These include the Cxl (Cancel) Buys button 82, the Cxl Sells button 84, and the Main 86, Actions 88, Synthetics 90, Pad 92 and Settings 94 buttons. When selected by the user the Cxl Buys and Cxl Sells buttons perform the expected functions, canceling all of the user's unfilled buy or sell orders, respectively. Selecting the Main button 86 opens a non-modal window that allows the user to change accounts and/or change the financial instrument associated with the open order entry window 50. Selecting the Actions button opens a non-modal window that allows the user to initiate a number of actions, including entering market buy orders and market sell orders, canceling all pending orders, centering the price thermometer, flattening the user's positions or reversing the user's positions. The Synthetics button 90 opens a non-modal window that allows the user to generate complex orders such as bracket orders and trailing stop orders whose implementation may require the creation of multiple buy or sell orders at various price levels. Selecting the Pad button 92 opens a pop-up window 96 that displays a numeric keypad that may be used for setting the quantity for each individual order. As mentioned above, the QTY Pad pop-up window operates in the same manner as the QTY columns 56, 64 and the QTY row 80, with the exceptions that the user may enter a quantity directly into a quantity input field 118 or the user may increment or decrement the quantity of an order by selecting the “+” and “-” buttons 120, 122 associated with the QTY Pad 96. Finally, selecting the Settings button 94 opens a non-modal window that allows the user to set or change various settings governing the operation and appearance of the order entry window.

A user interacts with the Order Entry window 50 to enter orders and have the orders executed on the exchange. An completed order requires a certain minimum amount of information in order execute. First, the order must specify the financial instrument that is the subject of the order. The order must further specify an order type (e.g., buy, sell, limit, stop, etc.), a quantity, and a price. An important characteristic of any effective trading platform is the efficiency and speed with which a trader may assemble the necessary data to create and submit orders. The Order Entry Window 50 of the trading platform herein disclosed allows users to quickly create and submit orders with only a few clicks of the mouse 32.

As has already been mentioned, an Order Entry window 50 may only be associated with one financial instrument. An order created within an Order Entry window 50 necessarily relates to the particular financial instrument with which the Order Entry window 50 is associated. In other words, if an Order Entry window 50 is opened for trading crude oil futures for July delivery, all orders entered in that Order Entry window 50 will necessarily be orders to buy or sell crude oil futures for July delivery. Orders for any other financial instrument must be entered in a different Order Entry window. Thus, the very act of creating an order within a particular Order Entry window 50 identifies the financial instrument to which the order relates. It remains then to specify the quantity, the order type and the price.

According to an embodiment of the trading platform of the present disclosure, a quantity must be selected for each order. The trading platform of the present disclosure provides a number of different ways for selecting the quantity. Each of the various ways of selecting the quantity is discussed in detail below. Once the quantity has been selected the price and the order type are selected by either right-clicking or left-clicking on the Bids or Asks columns 58, 62 adjacent the price at which the user wants to buy or sell the financial instrument. Left clicking the Bids or Asks column 58, 62 initiates a limit order to buy or sell the financial instrument at the adjacent price. Right-clicking the Bids or Asks column 58, 62 initiates a stop order to buy or sell the financial instrument at the adjacent price. Once the quantity for the transaction has been entered and the type of transaction has been identified based on whether a left-click or aright-click was used to click the Bids column or the Asks column 58, 62, and the price identified by the location of the left-click or right-click selecting the Bids or Asks column 58, 62, all of the information for executing the order is present and the order may be sent to the exchange for execution as soon as the price has been selected by left-clicking or right-clicking the Bids or Asks column 58, 62.

In another embodiment, the order of selecting the price and quantity may be reversed, or the order of price and quantity selection may be rendered irrelevant. According to this embodiment, the order type and price are again determined by right-clicking or left-clicking the Bids or Asks column 58, 62 adjacent the desired price. The quantity for the order may be selected by any of various methods described below. In this embodiment, however, the order will not be complete and will not be submitted to the exchange for execution until the user selects a separate Submit Order soft button 93 provided in the Order Entry window 50. In this case, the price and order type may be selected before the quantity because all of the information necessary to submit the order must be present before the submit button becomes active. The order in which the information is selected becomes irrelevant.

As mentioned above, a quantity must be individually selected for each order entered using the Order Entry window 50. The Order Entry window 50 includes a number of ways to select a quantity. A first method for entering a quantity for an order is to select a quantity using the numeric soft buttons included in the QTY columns 56, 64 the QTY row 80, or the QTY pad 92. (The QTY pad 92 is opened by selecting the Pad soft button located in the lower left region of the Order Entry window 50.) The numeric soft buttons in the QTY columns 56, 64, the QTY row 80 and the QTY pad 92 are additive. If a user desires to set a quantity that does not appear in the QTY columns 56, 64, the QTY row 80 or the QTY pad 92 the user may make a number of selections of the various numbered soft buttons whose numeric values add up to the desired quantity. To provide additional flexibility, right-clicking the various numeric soft buttons will subtract the corresponding value from the current quantity. As the user selects the Quantity for an order, the current quantity will be displayed 110 and highlighted in the order entry window 50.

The QTY Pad 92 also includes a “+” soft button 100 and a “−” soft button 102. The user may increment or decrement a current quantity by selecting the “+” soft button 100 or the “−” soft button 102, respectively. The QTY Pad 92 further includes a manual data entry field 98 in which a user may manually enter a desired quantity directly using the client workstation keyboard.

The QTY columns 56, 64, the QTY row 80 and the QTY Pad 92 each also include a RST soft button 74 and a POS soft button 76. Selecting the RST button 74 clears the current value, resetting the quantity and price to zero. Selecting the POS soft button 76 selects a quantity that equals the current position in an account that the user is currently trading in, whatever that position happens to be. Thus, if the user is long 17 lots of the particular financial instrument associated with the Order Entry window 50, selecting the POS button 76 in the QTY column 56, 64, the QTY row 80, or the QTY Pad 92 will set the quantity to 17. With this quantity the user may choose to double his or her position or close his or her position altogether. A user may also select a quantity via the Actions soft button 88. The Actions soft button 88 opens a non-modal window that includes, among other things, a Flatten soft button 89, and a Reverse soft button 91. Selecting the Flatten button 89 selects a quantity that equals the a current position in the account the user is trading in. This quantity is then used to populate an order that will take the opposite side of the current position in the account. When this transaction is executed, the net position in the account with respect to the financial instrument will be closed out. Selecting the Reverse soft button 91 has a similar effect. In this case, selecting Reverse soft button selects a quantity equal to twice the current position in the account the user is trading in. This quantity is then used to populate an order that will take the opposite side from the current position open in the account. When this transaction is executed, the net position in the account with respect to the financial instrument will be the opposite of that before the transaction was executed.

As an aside, the actions non-modal window further includes market buy and market sell buttons. These buttons initiate orders to buy and sell the financial instrument at the current market price. It must be noted, however, that before a market buy or market sell order can be executed, a quantity must be selected by one of the methods described above. The Actions non-modal window further includes a Cxl All soft button 97 which acts to cancel all of the user's unfilled orders. Finally, a Center soft button 99 acts to center the price thermometer as has already been described.

The order entry window 50 has two display modes of operation: Dynamic Price Display mode and Order Entry mode. The active mode is determined by the operating focus of the trading platform application. When operating focus is on some display window other than the Order Entry window 50, the Order Entry window 50 operates in the dynamic price display mode. If the operating focus is on the Order Entry window 50 , the Order Entry window 50 operates in the order entry mode. System focus is determined based on the position of the mouse cursor 162 relative to the various GUI windows. Whichever GUI window the cursor is located in will have operating focus. Thus, when the mouse cursor 38 is moved from another interface window into the Order Entry window 50, operating focus is shifted from the other interface window to the Order Entry window 50, and the Order Entry window 50 enters Order Entry mode.

In the Dynamic Price Display mode the prices displayed in the Price column 60 are updated dynamically as the market changes. The values that are displayed in the Price column 60 are centered on the last traded price and are re-centered whenever the last traded price changes. Alternatively, the values displayed in the Price column 60 may be centered on the highest current bid, lowest current ask or some other parameter of interest, depending on the user's needs and the configuration of the Order Entry window 50. In practice, however, the last traded price is the value of most significance, and in general the Order Entry window 50 will be configured to center the Price column 60 on the last traded price whenever the Order Entry window 50 is in Dynamic Price Display mode. Thus, for the remainder of this disclosure, it will be assumed that when the Order Entry window 50 is in the Dynamic Price Display mode the Price column 50 is automatically re-centered on the value of the last traded price, and the last traded price will always be displayed in the centermost position of the Price column 60.

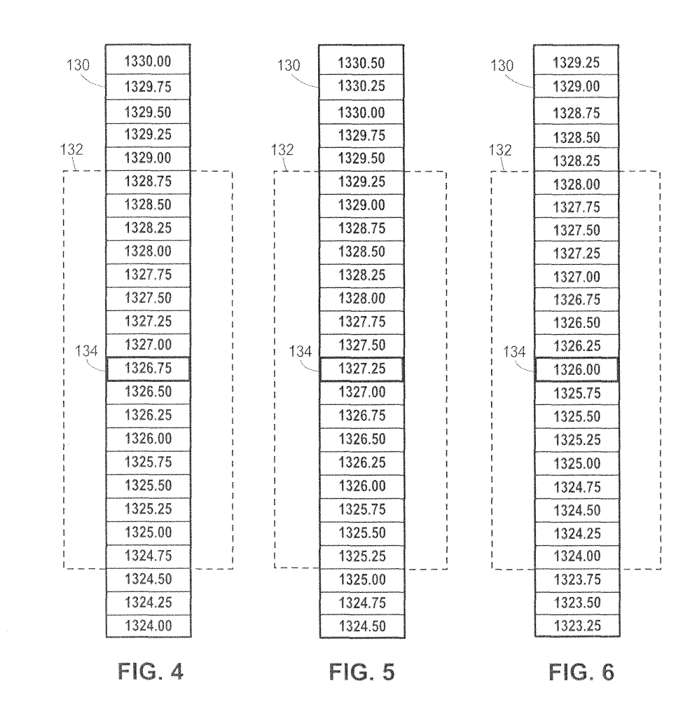

Dynamically centering the Price column 60 on the last traded price is illustrated in FIGS. 4, 5 and 6. FIG. 4 shows a portion of the price spectrum 130 for a financial instrument associated with an open Order Entry window 50. The dashed line 132 represents the portion of the price spectrum that is displayed in the Price column 60 of the Order Entry window 50. The center most position 134 of the Price column 60 displays the last traded price 1326.75. FIG. 5 shows the price spectrum for the same financial instrument after the price has increased by 2 ticks. The centermost position 134 of the Price column 60 remains in the same physical location of the Order Entry window 50, but the value displayed in the centermost position 132 is now 1327.25 rather than 1326.75, reflecting the increase of two ticks over the previous value of the last traded price shown in FIG. 4. The new last traded price may be highlighted green or displayed with green numerals indicating that the change from the previous last traded price represents an uptick in the market. The values displayed in all other positions within the Price column 60 are shifted as well. In effect, the entire price spectrum 130 has shifted downward through the displayed portion 132 of the Price column 60.

FIG. 6 shows the price spectrum 130 after the price of the of the financial instrument has dropped to 1326.00, a net change of five ticks from the price shown in FIG. 5. Again, the physical location of the centermost position 134 of the Price column 60 remains unchanged, but the value displayed therein has changed to 1326.00. In this case, the new value of the last traded price may be highlighted red or displayed with red numerals indicating that the change in the last traded price represents a downtick in the market relative to the last traded price displayed in FIG. 5. The values displayed in all other positions within the Price column 60 are shifted as well. In effect, the entire price spectrum 130 has shifted upward through the displayed portion 132 of the Price column 60.

If the price remains unchanged after a market update has been received, the price spectrum 130 does not move and the values displayed in the Price column 60 of the Order Entry window 50 remain unchanged. In this case, the value of the last traded price may be highlighted yellow, or displayed with yellow numerals to indicate that a market update has been received, but that the last traded price has not changed.

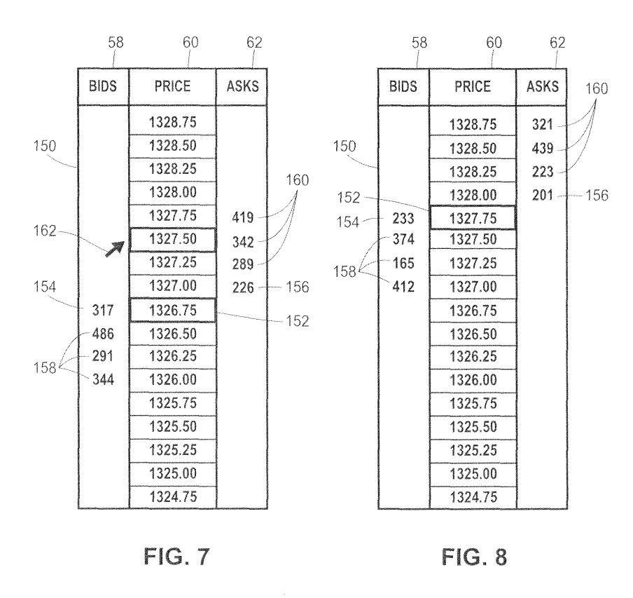

In Order Entry mode the dynamic display behavior of the Price column 60 is suspended. The values displayed in the Price column 60 are temporarily locked in place for a period of time such as for 30 seconds. During this period the values that were displayed in the price column 60 at the time that the Order Entry window 50 entered Order Entry mode remain displayed regardless of price movement in the market. FIGS. 7-10 illustrate the behavior of the Price column 60 as well as the Bids and Asks columns 58 and 62 when the Order Entry window 50 is in the Order Entry mode.

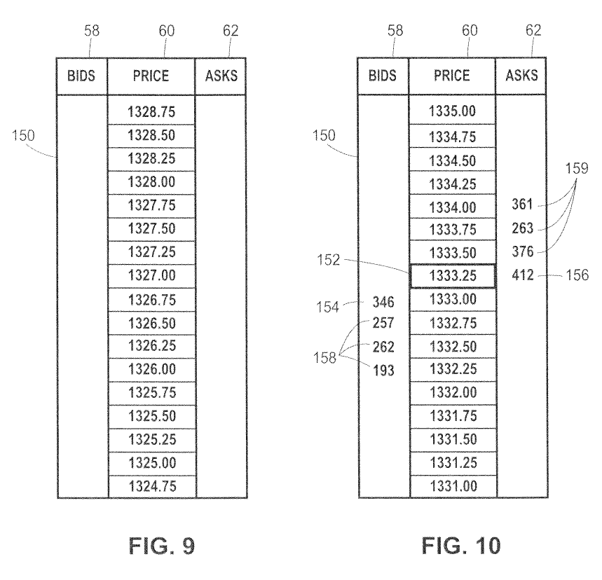

FIGS. 7-10 show a portion 150 of the of the Order Entry window 50 including the Bids column 58, the Price column 60 and the Asks column 62. The values displayed in the Bids, Price and Asks columns 58, 60, 62 in FIG. 7 reflect the values that were displayed when mouse cursor first moved into the Order Entry window 50 and the Order Entry window 50 entered Order Entry mode. FIG. 7 shows the last traded price 152, the best bid 154, and the lowest ask 156. The last traded price may be highlighted as described above to indicate whether the currently displayed last traded price corresponds to an uptick or a downtick in the market or whether the value was unchanged. The Bids and Asks columns 58, 62 also show the current number of active Bids and Asks pending at various price levels to show current market depth. FIG. 8 shows the same portion 150 of the Order Entry window 50 as FIG. 7 but after the price has changed and additional bids and asks have entered the market. Because the Price column 60 is locked, the values displayed in the Price column 60 remain the same and in the same positions as when the order entry window first entered the order entry mode. The last traded price 152 and the currently pending bids and asks, however, have moved to reflect the changes in the market since the Order Entry window 50 first entered the Order Entry mode. In FIG. 8 the last traded price has gone up 4 ticks. The new last traded price is highlighted (green in this case, indicating that the price has risen) in a new position indicating the new value of the last traded price. The pending Bids and Asks 158, 160 have also moved up alongside the Price column 60 indicating the altered conditions in the market. FIG. 9 shows the same portion 150 of the Order Entry window 50 as FIGS. 7 and 8 after the price has increased still further. In this case, the last traded price has risen to a value that is outside the range of values displayed in the Price column 60. As can be seen, the values displayed in the Price column remain the same as they were in FIGS. 7 and 8. The last traded price and pending bids and asks, however, are nowhere to be found because they now correspond to prices that are outside the range of price values displayed in the Price column 60. In this condition, the user's only indication of the current market is the last traded price value 108 displayed beneath the Price column 60 (See FIG. 3). Needless to say, this situation is not conducive to entering orders at current market conditions.

In Order Entry mode the user may reposition the price spectrum within the Price column 60 by placing the mouse cursor over the price column 60 using the scroll wheel on the mouse 32 (or some other scrolling input mechanism provided by some other type of input pointing device) to scroll the values of the prices spectrum up or down through the display column 60 until the desired prices are visible in the Order Entry window. FIG. 10 shows the same portion 150 of the Order Entry window 50 as FIGS. 7-9 after the user has re-positioned the price spectrum within the Price column 60. Here the last traded price 152, best bid 154, lowest ask 156 and other pending bids and ask 158, 160 are once again clearly visible within the displayed portion 150 of the order entry window 50. After re-positioning the price spectrum, the Price column 60 remains locked and will not re-center on the last traded price until the predetermined period of time has expired or until the user again manually re-centers the Price column using the mouse 32 scroll wheel.

As mentioned above, the Price column 60 is temporarily locked in the Order Entry mode. The Price column 60 will re-center on the most current value of the last traded price after a predetermined amount of time has passed. According to an embodiment, the Price column will remain locked for 30 seconds, at which time the Price column will automatically re-center on the last traded price. After 30 seconds the Price column 60 will revert to the Dynamic Price Display mode. In order to return to the order entry mode, operating focus must be withdrawn from the Order Entry window 50 and then returned to the Order Entry window 50. Alternatively, after 30 seconds, the Price column 60 may re-center on the last traded price current at the expiration of the first 30 second period, and remain locked at this new position for a second 30 second period. The Order Entry window 50 may continue in this mode until operating focus is withdrawn from the Order Entry Window 50.

Locking the Price column 60 in place allows the user to select prices for entering orders via the mouse without the fear that the prices will shift before the user selects the price. After 30 seconds, however, the Price column 60 will either return to dynamic re-centering on the last traded price or will re-center and lock on the last traded price current when the first 30 second period expired. Because this shift may occur when the User is about to select a price, it may be necessary to take precautions to ensure that the user actually selects the price he or she intends to select. As a first precaution for preventing a user from selecting the wrong price, in order entry mode the GUI may be adapted to highlight the price to which the cursor is pointing and which will be selected if the user left-clicks or right-clicks with the cursor at the current position. An example of this can be seen in FIG. 7. The cursor 162 is shown pointing to the price 1327.50 which is highlighted. (In black and white drawing the highlighting is displayed via a heavier line weight around the cell containing the value 1327.50, but on a full color display the entire cell may be changed to a different color such as blue.) The price 1327.50 will be entered in an order if the user right or left-clicks while this value is highlighted. Further, it may be beneficial to warn the user when the Price column 60 is about to re-center. Such a warning may take the form of a visual, audible, or tactile alarm, such as flashing the cursor 162 flashing on and off, or from one color to another at some user configurable predetermined time (e.g., 8 seconds) before the Price column 60 re-centers, sounding a bell or buzzer, causing the input device to vibrate, or the like. The type of alarm provided may be user selectable according to the user's preferences. Alternatively, the warning may comprise highlighting the entire Price column 60 and flashing the entire highlighted column, or changing the color of the displayed values and flashing the displayed values themselves when the Price column 60 is about to re-center. Alternatively, a visual warning may be displayed elsewhere in some user selectable location of the order entry window 50. In yet another alternative, a two-tiered alai in may be provided. For Example the cursor may be made to flash 8 seconds before the Price column 60 re-centers, and the entire Price column 60 may be made to flash beginning 3 seconds before the Price column 60 automatically re-centers.

As an added precaution, to prevent the user from selecting the wrong price when the Price column 60 re-centers after 30-second temporary lock expires, the user may be prevented from entering orders during a brief period immediately before and immediately after the Price column re-centers. For example, the user may be prevented from entering an order for one half second before and after the Price column 60 re-centers on the current last traded price the exclusion period need not be symmetric. For example, trading may be suspended 300 mSec before re-centering and for 500 mSec after re-centering. Preferably the trade exclusion period will be between 1-1000 mSec both before and after the prices column 60 is re-centered, and may be user configurable. Further, the length of the exclusion period both before and after re-centering may be made configurable.

In an alternative embodiment, rather than re-centering the Price column 60 on the last traded price immediately upon expiration of the 30-second lock period, the Price column 60 may be re-positioned in a series of steps. In this embodiment, the portion of the price spectrum displayed in the Price column 60 slowly shifts by one or a few ticks every few seconds until the current last traded price is displayed at or near the center of the Price column 60. In order that the user may interact with the prices at each step as the price spectrum slowly shifts back toward the center on the current last traded price value position, the price spectrum may be held at each position for an amount of time, such as 4 seconds or more, to allow the user to find the appropriate price and to interact with the appropriate price in its new position. As with the previously described embodiment it may be necessary to take precautions to prevent the user from selecting a price shortly before and after the price spectrum is scheduled to shift.

The present invention has been described with reference to specific examples. These examples are intended to be illustrative only and should not be read as limiting the invention in any way. It will be apparent to those of ordinary skill in the art that changes, additions or deletions may be made to the disclosed embodiments without departing from the spirit and scope of the invention.

What is claimed is:

1. A method of displaying market data comprising:
receiving market data from an exchange on which a financial instrument is traded, the market data including substantially real-time price data for the financial instrument, including a last traded price, a highest bid price, and a lowest ask price for the financial instrument;
displaying an interactive graphical user interface (GUI) window on a display device associated with a computer workstation executing a financial instrument trading application;
displaying a portion of a price spectrum in the GUI window, the price spectrum comprising a plurality of incremental price values linearly arranged in numeric order;
determining whether the GUI window has operational focus of the trading application;
displaying the portion of the price spectrum in the GUI window in a first mode when the GUI window does not have operational focus of the trading application, in the first mode the portion of the price spectrum being dynamically displayed in the GUI window centered on one of the last traded price, the highest bid price, or the lowest ask price; and
displaying the portion of the price spectrum in the GUI window in a second mode when the GUI window has operational focus of the trading application, in the second mode the portion of the price spectrum being displayed for a first predefined period of time centered on a first value of one of the last traded price, the highest bid price, or the lowest ask price, the first value of the last traded price, the highest bid price, or the lowest ask price being established at a time when the GUI window received operational focus of the trading application, and wherein, upon expiration of the period of time, the portion of the price spectrum displayed in the GUI being displayed centered on a second value of the last traded price highest bid price, or lowest ask price established at the expiration of the first period of time.

2. The method of claim 1 wherein the portion of the price spectrum displayed in the GUI window centered on the second value of the last traded price established at the Expiration of the first period of time is displayed for a second period of time.

3. The method of claim 1 further comprising displaying the portion of the price spectrum in the GUI window in the first mode after expiration of the first period of time.

4. The method of claim 2 wherein displaying the portion of the price spectrum displayed in the GUI window centered on the second value of the last traded price, highest bid price, or lowest ask price established at the expiration of the first period of time comprises shifting the displayed portion of the price spectrum over time until the second value of the last traded price is centered within the GUI window.

5. The method of claim 1 wherein determining whether the GUI window has operational focus of the trading application comprises determining a position of a user positionable cursor, the GUI window having operation focus of the trading application when the cursor is positioned over the GUI window.

6. The method of claim 1 further comprising issuing an alert prior to the expiration of the period of time indicating that the portion of the price spectrum displayed in the GUI window may change upon expiration of the period of time.

7. The method of claim 6 wherein the alert is issued a user selectable amount of time prior to the expiration of the first period of time.

8. The method of claim 6 wherein issuing an alert prior to the expiration of the first period of time comprises issuing one of a visual alert, an audio alert, or a tactile alert.

9. The method of claim 8 wherein the type of alert issued is user selectable.

10. The method of claim 8 wherein the alert is a visual alert, and wherein the location of the visual alert within the GUI window is user selectable.

11. The method of claim 6 wherein the alert comprises causing a user positionable cursor to begin flashing an amount of time before the expiration of the period of time.

12. The method of claim 6 wherein the alert comprises highlighting the portion of the price spectrum displayed in the GUI a different color and flashing the highlighted color an amount of time before the expiration of the period of time.

13. The method of claim 6 wherein the alert comprises changing a display color the price values of the portion of the of the price spectrum displayed in the GUI window, and causing the price values to flash an amount of time before the expiration of the period of time.

14. The method of claim 1 further comprising preventing orders from being entered via a trading application associated with the GUI for an order disable period immediately preceding expiration of the period of time.

15. The method of claim 1 further comprising preventing orders from being entered via a trading application associated with the GUI for an order disable period immediately following expiration of the period of time.

16. The method of claim 1 further comprising preventing orders from being entered via a trading application associated with the GUI for a first order disable period immediately preceding the expiration of the period of time, and a second order disable period immediately following the expiration of the period of time.

17. The method of claim 16 wherein the first order disable period and the second order disable period are in the range from 1 mSec to 1000 mSec long.

18. The method of claim 16 further comprising allowing a user to configure a length of time for both the first order disable period and the second order disable period.

19. A system for trading a financial instrument on an exchange, the system comprising:
a processor;
a display device;
an input device adapted to control a position of a cursor on the display device and to register user selection of one or more graphical objects displayed on the display device;
a communication module for receiving market data associated with the financial instrument from the exchange and for sending orders to the exchange to buy or sell the financial instrument; and
a memory storing instructions which, when executed by the processor, cause the processor to display a graphical user interface (GUI) on the display device, the GUI including an order entry window that includes:
a price display region adapted to display a portion of a price spectrum associated with the financial instrument in a first mode when the cursor is positioned outside the order entry window, and in a second mode when the cursor is positioned within the order entry window;
the first mode comprising a dynamic price display mode in which the display region is continuously updated to reflect the market data received from the exchange as the data are received such that a portion of the price spectrum centered on an instantaneous price is displayed in the display region; and
the second mode comprising a static price display mode in which a portion of the price spectrum centered on a price determined at a time when the cursor is moved into the order entry window is displayed on the display for a period of time, and a portion of the price spectrum centered on a price determined at the expiration of the period of time is displayed in the display region after the expiration of the period of time.

20. The system of claim 19 wherein the second mode further comprises displaying the portion of the price spectrum centered on a price determined at the expiration of the first period of time for a second period of time.

21. The system of claim 19 wherein displaying the portion of the price spectrum displayed in the GUI window centered on a price established at the expiration of the first period of time comprises shifting the displayed portion of the price spectrum over time until the price established at the expiration of the first period of time is centered within the GUI window.

22. The system of claim 19 wherein the portion of the price spectrum displayed in the display region is displayed in the first mode after expiration of the first period of time in the second mode until such time as the user moves the cursor out of the order entry window and subsequently moves the cursor back into the order entry window.

23. The system of claim 19 wherein the instructions stored in the memory, when executed by the processor, cause the processor to display a GUI on the display device that generates a warning in the static price display mode prior to the expiration of the period of time indicating that the portion of the price spectrum displayed in the display region will soon be re-centered on the price determined at the expiration of the period of time.

24. The system of claim 23 wherein an amount of time before expiration of the period of time at which the warning is generated is user configurable via the GUI.

25. The system of claim 23 wherein the warning comprises a type of warning that is at least one of a visual warning, an audible warning, or a tactile warning.

26. The system of claim 25 wherein the type of warning is user selectable.

27. The system of claim 23 wherein the warning comprises a visual warning displayed in a user selectable location within the order entry window.

28. The system of claim 23 wherein the warning comprises causing the cursor to begin flashing an amount of time before the expiration of the period of time.

29. The system of claim 23 wherein the warning comprises highlighting the portion of the price spectrum displayed in the display region in a different color and flashing the highlighted color an amount of time before the expiration of the period of time.

30. The system of claim 23 wherein the warning comprises changing a display color of the portion of the of the price spectrum displayed in the display region, and causing the portion of the price spectrum displayed in the display region to flash an amount of time before the expiration of the period of time.

31. The system of claim 19 wherein the instructions stored in the memory, when executed by the processor, cause the processor to prevent orders from being entered during an order disable period immediately preceding expiration of the period of time.

32. The method of claim 19 wherein the instructions stored in the memory, when executed by the processor, cause the processor to prevent orders from being entered during an order disable period immediately following expiration of the period of time.

33. The method of claim 19 wherein the instructions stored in the memory, when executed by the processor, cause the processor to prevent orders from being entered during an order disable period immediately preceding expiration of the period of time and to prevent orders from being entered during an order disable period immediately following expiration of the period of time.

34. The system of claim 33 wherein the first order disable period and the second order disable period are both in the range between 1 mSec-1000 mSec long.

35. The system of claim 33 wherein the first order disable period and the second order period are user configurable.

36. The system of claim 19 wherein the instructions stored in the memory, when executed by the processor, cause the processor to display a GUI on the display device that further includes a plurality of quantity selection graphical elements for setting an order quantity for an order to buy or sell the financial instrument.

37. The system of claim 36 wherein the instructions stored in the memory, when executed by the processor, cause the processor to display a GUI that includes a quantity value corresponding to a selected quantity for an order to buy or sell the financial instrument.

38. The system of claim 37 wherein the instructions stored in the memory, when executed by the processor cause the processor to display a GUI that visually highlights the quantity value corresponding to a selected quantity for an order to buy or sell the financial instrument.

39. The system of claim 36 wherein the quantity selection graphical elements comprise a plurality of numbered icons, wherein a value equal to the number of a particular one of the plurality of numbered icons is added to an order quantity when the particular one of the plurality of numbered icons is selected by a user via a primary input action with respect to the input device.

40. The system of claim 39 a value equal to the number of a particular one of the plurality of numbered icons is subtracted from an order quantity when the particular one of the plurality of numbered icons is selected by a user via an alternate input action with respect to the input device.

41. The system of claim 39 wherein the values of the numbered icons comprising the quantity selection graphical elements are user selectable.

42. The system of claim 36 wherein the quantity selection graphical elements comprise an increment icon which, when selected by a user via the input device, increments an order quantity by a predefined amount.

43. The system of claim 36 wherein the quantity selection graphical elements comprise an decrement icon which, when selected by a user via the input device, decrements an order quantity by a predefined amount.

44. The system of claim 36 wherein the quantity selection graphical elements comprise a flatten position icon which, when selected by a user via the input device, sets an order quantity equal to an amount that equals a current position for the financial instrument in an account the user is currently trading in for an order taking a position opposite the current position in the account.

45. The system of claim 36 wherein the quantity selection graphical elements comprise a reverse position icon which, when selected by a user via the input device, sets an order quantity equal to an amount double a current position for the financial instrument in an account the user is currently trading in for an order taking a position opposite the current position in the account.

46. The system of claim 36 wherein the quantity selection graphical elements comprise a position icon which, when selected by a user via the input device, sets an order quantity equal to an amount that equals a current position for the financial instrument in an account the user is currently trading in.

47. The system of claim 36 wherein the quantity selection graphical elements comprise a quantity entry field into which the user may manually enter a quantity for an order to buy or sell the financial instrument.

48. The system of claim 36 wherein the quantity selection graphical elements comprise a reset quantity icon which, when selected by a user via the input device, sets an order quantity to zero for a current order.

49. The system of claim 48 wherein, when selected by a user via the input device, the reset quantity icon sets an order price to zero.

50. The system of claim 36 wherein the instructions stored in the memory, when executed by the processor, cause the processor to display a GUI on the display device that further includes a submit graphical element for submitting an order to the exchange for execution, the order including an order quantity and a price.

51. An interface for displaying market data associated with a financial instrument traded on an exchange and for receiving user input for placing orders to buy and sell the financial instrument on the exchange, the interface comprising:
a display device for presenting a plurality of interactive windows in a display area;
an input device for interacting with the interactive windows;
one of the interactive window comprising an order entry window displayed on the display device, the order entry window including a price display region adapted to display a plurality of price values in one of a dynamic price monitoring mode and a static order entry mode, in the dynamic price monitoring mode the plurality of price values displayed in the price display region are updated on a substantially continuous basis according to market data received from the exchange and are displayed centered around one of a last traded price value a highest bid price or a lowest ask price, in the static order entry mode the plurality of price values are statically displayed for a first period of time centered around one of a last traded price value a highest bid price, or a lowest ask price displayed at the time the interface entered the order entry mode, and wherein the plurality of price values are displayed centered around a new last traded price, highest bid price, or lowest ask price corresponding to the last traded price value highest bid price value or lowest ask price value received from the exchange at a time corresponding to the time when the first period of time expires.

52. The interface of claim 51 wherein the plurality of price values are displayed for a second period of time centered around the new last traded price value, highest bid price value or lowest ask price value, corresponding to the last traded price value, highest bid price value, or lowest ask price value received from the exchange at the time corresponding to the time when the first period of time expired, and wherein the plurality of price values are displayed centered around yet another new last traded price value highest bid price value, or lowest ask price value corresponding to the time when the second period of time expires.

53. The interface of claim 51 wherein displaying the portion of the price spectrum displayed in the GUI window centered on the new last traded price value, highest bid price value or lowest ask price value, established at the expiration of the first period of time comprises shifting the displayed portion of the price spectrum over time until the second value of the last traded price value, highest bid price value or lowest ask price value is centered within the GUI window.

54. The interface of claim 51 wherein the static order entry mode reverts to the dynamic price monitoring mode when the first period of time expires.

55. The interface of claim 51 wherein operational focus of the interface may only be directed to one of the plurality of interactive windows at a time, and wherein operational focus is determined according to position of a user positionable cursor within the display area, the interactive window having operation focus being the interactive window in which the cursor is located.

56. The interface of claim 51 wherein order entry window is adapted to provide an alert prior to the expiration of the period of time indicating that the plurality of price values centered around the last traded price value displayed at the time the interface entered the order entry mode will soon change to the plurality of price values centered around the new last traded price value corresponding to the last traded price valued received when the time period expires.

57. The interface of claim 56 wherein an amount of time prior to the expiration of the period of time at which the alert is issued is user selectable.

58. The interface of claim 56 wherein the alert comprises one of a visual alert, an audible alert, or a tactile alert.

59. The interface of claim 56 wherein the alert comprises a visual alert displayed at a user selectable location within the order entry window.

60. The interface of claim 56 wherein the alert comprises causing a user positionable cursor to begin flashing an amount of time before the time period expires.

61. The interface of claim 56 wherein the alert comprises highlighting the portion of the price display region in a different color and flashing the highlighted color an amount of time before the time period expires.

62. The interface of claim 56 wherein the alert comprises changing a display color of the price values displayed in the price display region and causing the price values to flash an amount of time before the time period expires.

63. The interface of claim 51 further adapted prevent orders from being entered during a first order disable period immediately preceding expiration of the time period.

64. The interface of claim 63 further adapted to prevent orders from being entered for a second order disable period immediately following expiration of the time period.

65. The interface of claim 64 further adapted to prevent orders from being entered for a first order disable period immediately preceding expiration of the time period, and a second order disable period immediately following expiration of the time period, wherein the first order disable period and the second order disable period are both in the range from 1 mSec-1000 mSec.

66. The interface of claim 64 wherein the first order disable period and the second order disable period are configurable.

67. The interface of claim 51 further comprising further comprising a plurality of quantity selection graphical elements for setting an order quantity for an order to buy or sell the financial instrument.

68. The interface of claim 67 further comprising a displayed quantity value corresponding to a selected quantity for the order to buy or sell the financial instrument.

69. The interface of claim 67 wherein the quantity selection graphical elements comprise a plurality of numbered icons, and wherein a value equal to the number of a particular one of the plurality of numbered icons is added to an order quantity when the particular one of the plurality of numbered icons is selected by a user via the input device.

70. The interface of claim 69 wherein the values of the plurality of numbered icons comprising the quantity selection graphical elements are user selectable.

71. The interface of claim 67 wherein the quantity selection graphical elements comprise a plurality of numbered icons, wherein a value equal to the number of a particular one of the plurality of numbered icons is subtracted from an order quantity when the particular one of the plurality of numbered icons is selected by an alternate selection by the user via the input device.

72. The interface of claim 67 wherein the plurality of quantity selection graphical elements are displayed in the order entry window in a user selectable location.

73. The interface of claim 67 wherein the quantity selection graphical elements comprise an increment icon which, when selected by a user via the input device, increments an order quantity by a predefined amount.

74. The interface of claim 67 wherein the quantity selection graphical elements comprise an decrement icon which, when selected by a user via the input device, decrements an order quantity by a predefined amount.

75. The interface of claim 67 wherein the quantity selection graphical elements comprise a flatten position icon which, when selected by a user via the input device, sets an order quantity equal to an amount that equals a current position for the financial instrument in an account administered by the user for an order taking a position opposite the current position in the account.

76. The interface of claim 67 wherein the quantity selection graphical elements comprise a reverse position icon which, when selected by a user via the input device, sets an order quantity equal to an amount double a current position for the financial instrument in an account administered by the user for an order taking a position opposite the current position in the account.

77. The interface of claim 67 wherein the quantity selection graphical elements comprise a position icon which, when selected by a user via the input device, sets an order quantity equal to an amount that equals a current position for the financial instrument in an account administered by the user.

78. The interface of claim 67 wherein the quantity selection graphical elements comprise a quantity entry field into which the user may manually enter a quantity for an order to buy or sell the financial instrument.

79. The interface of claim 67 wherein the quantity selection graphical elements comprise a reset quantity icon which, when selected by the user via the input device sets an order quantity to zero.

80. The interface of claim 79 wherein, when selected by a user via the input device, the reset quantity icon sets an order price to a zero.

81. The interface of claim 51 wherein the order entry window further includes a submit graphical element for submitting an order to the exchange for execution, the order including an order quantity and a price.

82. A method of entering an order to by or sell a financial instrument on an exchange, the method comprising:
providing a graphical user interface (GUI) for receiving market data related to the financial instrument;
presenting a plurality of price options via the GUI for buying and selling the financial instrument;
setting an order quantity to zero;
providing a graphical element via the GUI for setting the order quantity to a value corresponding to a desired order quantity;
receiving an input via user interaction with the graphical element for setting the order quantity to a non-zero value;
setting the order quantity to the non-zero value;
receiving a buy or sell input via the GUI corresponding to a price selected from among said plurality of price options, the input further indicating an order type;
sending an order to the exchange to buy or sell the financial instrument, the order specifying a price corresponding to the price selected from among said plurality of price options, and an order type corresponding to the order type indicated by the received buy or sell input, and a quantity corresponding to the non-zero value; and
resetting the order quantity to zero.

83. The method of claim 82 wherein providing a graphical element via the GUI for setting the order quantity comprises providing a plurality of user selectable numbered icons having user selectable values.

84. The method of claim 83 wherein providing the plurality of user selectable icons comprises displaying the plurality of user selectable icons at user selectable locations within the GUI.

85. The method of claim 82 further comprising displaying the order quantity via the GUI.

86. The method of claim 85 further comprising highlighting the displayed order quantity.

87. The method of claim 82 wherein the graphical element for setting the order quantity comprises a plurality of numbered icons, and wherein receiving an input via user interaction with the graphical element for setting the order quantity to a non-zero value comprises a user selecting a particular one of the plurality of numbered icons, and wherein the method further comprises adding a value equal to the number of the particular one of the plurality of numbered icons selected by the user to the order quantity.

88. The method of claim 87 further comprising a user selecting a particular one of the numbered icons using an alternate input associated with the input and device, and subtracting a value equal to the number of the particular one of the plurality of numbered icons selected using the alternate input from the order quantity.

89. The method of claim 82 wherein the graphical element for setting the order quantity comprises an increment icon, and wherein receiving an input via user interaction with the graphical element for setting the order quantity to a non-zero value comprises a user selecting the increment icon, and wherein the method further comprises incrementing the order quantity by a predefined amount.

90. The method of claim 82 wherein the graphical element for setting the order quantity comprises an decrement icon, and wherein receiving an input via user interaction with the graphical element for setting the order quantity to a non-zero value comprises a user selecting the decrement icon, and wherein the method further comprises decrementing the order quantity by a predefined amount.

91. The method of claim 82 wherein the graphical element for setting the order quantity comprises a flatten position icon, and wherein receiving an input via user interaction with the graphical element for setting the order quantity to a non-zero value comprises a user selecting the flatten icon, and wherein the method further comprises setting the order quantity equal to an amount that equals a current position for the financial instrument in an account administered by the user for an order taking a position opposite the current position open in the account.

92. The method of claim 82 wherein the graphical element for setting the order quantity comprises an reverse icon, and wherein receiving an input via user interaction with the graphical element for setting the order quantity to a non-zero value comprises a user selecting the reverse icon, and wherein the method further comprises setting the order quantity equal to an amount double a current position for the financial instrument in an account administered by the user for an order taking a position opposite the current position open in the account.

93. The method of claim 82 wherein the graphical element for setting the order quantity comprises a position icon, and wherein receiving an input via user interaction with the graphical element for setting the order quantity to anon-zero value comprises a user selecting the position icon, and wherein the method further comprises setting the order quantity equal to an amount that equals a current position for the financial instrument in an account administered by the user.

94. The method of claim 82 wherein the graphical element for setting the order quantity comprises a manual input field, and wherein receiving an input via user interaction with the reset icon for setting the order quantity to a non-zero value comprises a user manually entering a value in the manual input field, and wherein the method further comprises setting the order quantity equal to the value manually entered in the manual input field for an order to buy or sell the financial instrument.

95. The method of claim 82 wherein the graphical element for setting the order quantity comprises a reset icon, the method further comprising receiving an input via user interaction with the graphical element, and setting the order quantity to zero upon receiving the input.

96. The method of claim 95 wherein, when selected by a user via the input device, the reset quantity icon sets an order price to a zero.

97. The method of claim 82 wherein providing a GUI further includes providing a graphical element for submitting an order to the exchange for execution, the order including an order quantity and a price.
